(19) United States
(12) Patent Application Publication
(10) Pub. No.: US 2007/0299812 A1
(43) Pub. Date: Dec. 27, 2007

(54) Workload manager for relational database management systems

(75) Inventor: David Salch, Chino Hills, CA (US)

Correspondence Address: MCDERMOTT WILL & EMERY LLP, 18191 VON KARMAN AVE., SUITE 500, IRVINE, CA, 92612-7108, US

(73) Assignee: DATALLEGRO, INC., Aliso Viejo, CA (US)

(21) Appl. No.: 11/823,227

(22) Filed: Jun. 26, 2007

Related U.S. Application Data
(60) Provisional application No. 60/816,910, filed on Jun. 26, 2006.

(51) Int. Cl. G06F 17/30

(52) U.S. Cl. 707/2

(57) ABSTRACT

A relational database workload manager is provided for dynamically managing processing priorities assigned to queries executing within a relational database management system (RDBMS). The workload manager monitors executing query process threads and at set time intervals reduces the processing priority assigned to each executing query. This automated method of managing relational database queries allows short executing queries within a mixed database workload to remain relatively quick without complicated setup and management.

This application claims the benefit of U.S. Provisional Application No. 60/816,910, filed on Jun. 26, 2006, which is hereby incorporated by reference.

### FIELD OF THE INVENTION

The invention relates to the field of relational database management systems and, in particular, relates to a system for managing the workload of relational database management systems.

### BACKGROUND OF THE INVENTION

Relational database management systems (RDBMS) typically allow for multiple concurrent connections and queries to be submitted by independent users for processing. These multiple tasks make up the workload of the RDBMS. As this workload increases, it typically will include a mix of short simple queries and long processing intensive queries. The users submitting these queries generally are unaware of the activities of each other. Therefore within this mixed workload there can be several submissions of expected short executing simple queries as well as several long executing processing intensive queries.

Short executing queries can be described as fairly simple operations which when executed individually complete in a relatively short time. Long executing queries can be described as queries which must aggregate or group large amounts of data to complete. The difference in completion times can be sub-second for short executing queries and minutes to hours for long executing queries.

With no workload management, all queries receive equal processing priority. As the number of concurrent queries increases, the performance for each individual query decreases nearly linearly. For example, two queries executing concurrently will both take nearly twice as long as either query executing individually. Similarly, four queries executing concurrently will complete in about four times as long as would used if executing individually. This performance curve is unacceptable to end users who expect short executing queries to remain short.

### SUMMARY OF THE INVENTION

The invention provides automatic management of the concurrent workload within a relational database management system so that queries that are expected to execute quickly will receive priority of processing resources and therefore remain as consistently fast as possible, without complicated configuration. The relational database workload manager described herein preserves the quick completion of these expectedly quick queries within a mixed workload of query types by automatically adjusting processing priority within the computer system. The resulting relational database system is one which automatically matches performance to user expectation even under high load conditions.

According to one embodiment of the invention, a method for managing a relational database workload is provided. The method includes monitoring executing queries in a relational database management system and reducing a priority assigned to each executing query at set time intervals.

According to another embodiment of the invention, a relational database workload manager is provided. The relational database workload manager includes a processing system configured to monitor executing queries in a relational database management system and to reduce a priority assigned to each executing query at set time intervals.

According to another embodiment of the invention, a machine-readable medium is provided that includes instructions executable by a processing system in a relational database workload manager. The instructions include steps for monitoring executing queries in a relational database management system and reducing a priority assigned to each executing query at set time intervals.

The foregoing summary of the invention has been provided so that the nature of the invention can be understood quickly. A more detailed and complete understanding of the preferred embodiments of the invention can be obtained by reference to the following description of the invention together with the associated drawings.

### BRIEF DESCRIPTION OF THE DRAWINGS

FIG. 1 is a schematic diagram depicting a relational database system together with multiple user stations interconnected by a network.

FIG. 2 is a block diagram depicting components of a computing system upon which a relational database system may be implemented according to one embodiment of the invention.

FIG. 3 is a flowchart depicting steps performed by a relational database workload manager according to one embodiment of the invention.

FIG. 4 is a graph depicting the dynamic adjustment of thread priority associated with three threads according to one embodiment of the invention.

### DESCRIPTION OF THE INVENTION

The detailed description of the invention set forth below in connection with the associated drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without all of the specific details contained herein. In some instances, well known structures and components are shown in block diagram form in order to avoid obscuring the concepts of the invention.

A relational database workload manager is described to facilitate control of the processing priority given to individual queries within a mixed workload. The workload manager applies a novel algorithm to dynamically adjust the processing priority of queries as they execute within the RDBMS. When a new query is submitted for execution, a high processing priority is assigned to the query. At pre-determined intervals of time, the processing priorities of still executing queries are lowered by a pre-determined amount, as will be described in more detail below.

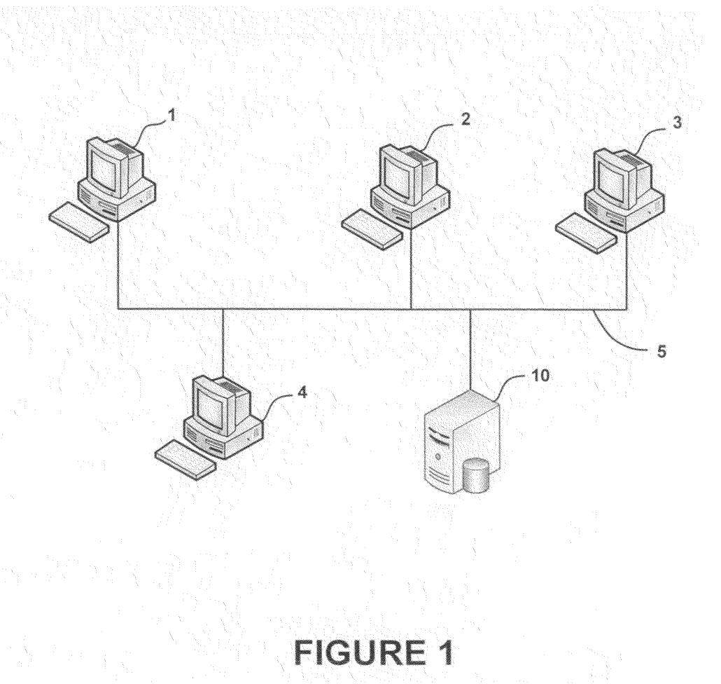

FIG. 1 is a schematic diagram depicting a relational database system 10 together with multiple user stations 1-4 interconnected by network 5. Relational database system 10 includes a RDBMS for managing access to a database by user stations 1-4. Relational database system 10 further includes a workload manager to manage the workload of the RDBMS when concurrent access to the relational database is provided for multiple users.

User stations 1-4 are intended to represent any computing device or system capable of generating and submitting a query to relational database system 10. For example, user stations 1-4 may include, but are not limited to, a work station, a terminal, or a handheld device configured for accessing the relational database within relational database system 10. Relational database system 10 is configured to accommodate concurrent access to its relational database from any number of user stations 1-4, which each access the relational database independent of the other user stations. A user operating one of user stations 1-4 may or may not be aware of the queries submitted by other users operating other ones of user stations 1-4. While FIG. 1 depicts only four user stations, it is to be understood that the number of user stations capable of accessing relational database system 10 may be fewer than four user stations or may exceed four user stations without departing from the scope of the invention.

As shown in FIG. 1, user stations 1-4 are interconnected with relational database system 10 by a network 5. Network 5 is intended to represent a two-way data communication system such as a local area network (LAN), a wide area network (WAN), the Internet, etc. Network 5 may be implemented using either wired or wireless technologies and any of a number of protocols known to those skilled in the art. It is to be understood that the communication of queries between user stations 1-4 and relational database system 10 is not limited to any particular network technology or protocol. Furthermore, it is to be understood that multiple network technologies and/or protocols may be used to interconnect user stations 1-4 with relational database system 10.

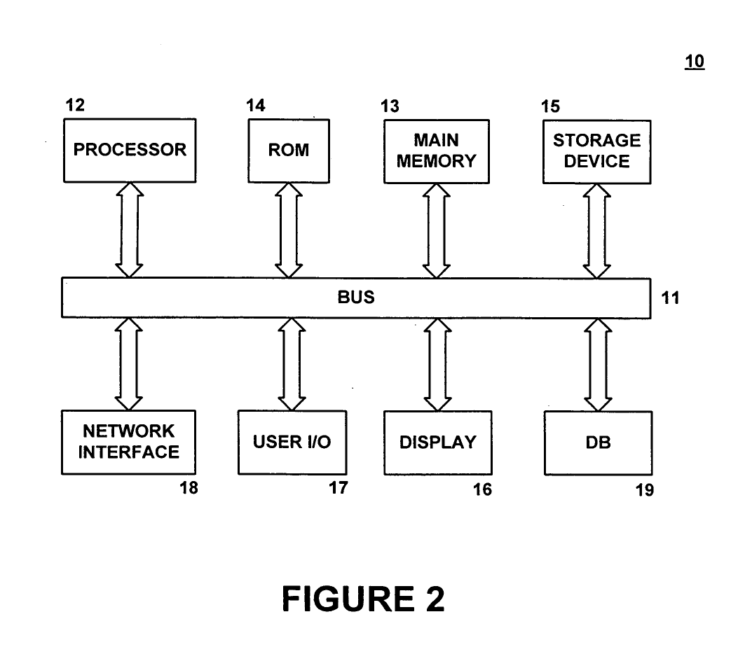

FIG. 2 is a block diagram that illustrates a computing system upon which relational database system 10 may be implemented according to one embodiment of the invention. Relational database system 10 includes a bus 11 or other communication mechanism for communicating information, and a processor 12 coupled with bus 11 for processing information. Relational database system 10 also includes a main memory 13, such as a random access memory (RAM) or other dynamic storage device, coupled to bus 11 for storing information and instructions to be executed by processor 12. Main memory 13 also may be used for storing temporary variables or other intermediate information during the execution of instructions by processor 12. Relational database system 10 further includes a read only memory (ROM) 14 or other static storage device coupled to bus 11 for storing static information and instructions for processor 12. A storage device 15, such as a magnetic disk or an optical disk, is provided and coupled to bus 11 for storing information and instructions.

Relational database system 10 may be coupled via bus 11 to a display 16, such as a liquid crystal display (LCD) or a cathode ray tube (CRT), for displaying information to a user such as a database administrator. A user I/O device 17 for communication information and command selections to processor 12 also may be coupled to bus 11. User I/O device 17 includes a keyboard containing alphanumeric and other keys as well as a cursor control device such as a mouse, a trackball, or cursor direction keys for communicating direction information and command selections to processor 12 and for controlling cursor movement on display 16.

According to one embodiment of the invention, an operating system, a RDBMS and a workload manager are implemented on relational database system 10 in response to processor 12 executing one or more sequences of instructions contained in main memory 13. Such instructions may be read into main memory 13 from another machine-readable medium, such as storage device 15. Execution of the sequences of instructions contained in main memory 13 causes processor 12 to perform the process steps described in more detail below. One or more processors in a multi-processing arrangement may also be employed to execute the sequences of instructions contained in main memory 13. In alternative embodiments, hard-wired circuitry may be used in place of or in combination with software instructions to implement the invention. Thus, embodiments of the invention are not limited to any specific combination of hardware circuitry and software. In addition, the invention is not limited to any particular operating system or RDBMS and may be implemented using any of a number of commercial and/or open source systems, as will become apparent to those skilled in the art. For example, one embodiment of the invention uses a LINUX based operation system and an open source RDBMS provided by Ingres.

The term “machine-readable medium” as used herein refers to any medium that participates in providing instructions to processor 12 for execution. Such a medium may take many forms, including, but not limited to, non-volatile media, volatile media, and transmission media. Non-volatile media include, for example, optical or magnetic disks, such as storage device 15. Volatile media include dynamic memory, such as main memory 13. Transmission media include coaxial cables, copper wire, and fiber optics, including the wires that comprise bus 11. Transmission media can also take the form of acoustic or light waves, such as those generated during radio frequency (RF) and infrared (IR) data communications. Common forms of machine-readable media include, for example, a floppy disk, a flexible disk, a hard disk, magnetic tapes or any other magnetic medium, a CD-ROM, DVD-ROM, and any other optical medium. Machine-readable media also includes other forms of memory such as PROM, EEPROM, FLASH memory, and other memory chip or cartridge formats. In summary, a machine-readable media represents any medium from which a processor can read data and instructions.

Various forms of machine-readable media may be involved in carrying one or more sequences of instructions to processor 12 for execution. For example, the instructions may initially be borne on a magnetic disk on a remote computer. The remote computer may load the instructions into its dynamic memory and send the instructions to relational database system 10 via a network or over a telephone line. Relational database system 10 receives the instructions at network interface 18 coupled to bus 11. After being placed on bus 11 by network interface 18, bus 11 carries the data to main memory 13, from which processor 12 retrieves and executes the instructions. The instructions received by main memory 13 may optionally be stored on storage device 15 either before or after execution by processor 12. Processor 12 and the machine-readable media on which relevant instruction sequences are stored represent a processing system configured to implement various embodiments of the invention described herein.

As noted above, relational database system 10 also includes a network interface 18 coupled to bus 11. Network interface 18 provides a two-way data communication coupling to network 5. Network interface 18 may be a local area network (LAN) card to provide a data communication connection to a compatible LAN. Wireless links may also be implemented. In any such implementation, network interface 18 sends and receives electrical, electromagnetic or optical signals that carry digital data streams representing various types of information. Network interface 18 also may provide two-way data communication with wide area networks (WAN) and the Internet.

Also depicted in FIG. 2 is DB 19, which is intended to represent the machine-readable media on which the tables of a relational database managed by the RDBMS executed on relational database system 10 are stored. One skilled in the art will recognize that various types of machine-readable media may be used to store the relational database tables, including optical and/or magnetic disks and disk arrays. One skilled in the art also will recognize that DB 19 may be incorporated in another server connected to relational database system 10 via network 5. Even though DB 19 is depicted separate from storage device 15, the relational database tables may be stored in storage device 15 in alternative implementations.

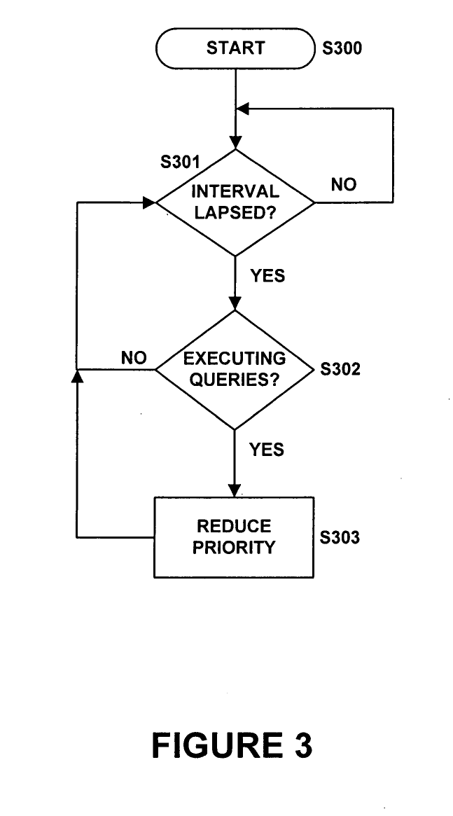

As noted above, relational database system 10 includes a relational database workload manager implemented by executing a sequence of instructions in relational database system 10. The relational database workload manager dynamically adjusts the priority assigned to concurrently executing queries within the RDBMS of relational database system 10. FIG. 3 is a flowchart depicting steps performed by the relational database workload manager according to one embodiment of the invention. In summary, the workload manager monitors queries being executed by the RDBMS and at the lapsing of a time interval reduces the priority assigned to each query still being executed. This process will now be described in more detail.

In step S300, the workload manager is launched by starting execution of the sequence of instructions within relational database system 10. This initiation of the workload manager may be tied to the launching of the RDBMS within relational database system 10 such that it is launched automatically every time the RDBMS is launched. Alternatively, the workload manager may be configured to be launched separate from the RDBMS to allow an administrator the option of whether or not to activate the workload manager. According to one embodiment, the workload manager is implemented using a UNIX daemon within a UNIX-based operating system. In this embodiment, the daemon may be configured to execute at the lapse of each time interval.

Upon initiation, the workload manager enters a state where it waits until a time interval has lapsed. This state is represented in FIG. 3 by step S301. The time interval initially is set to a default value, but is adjustable by an administrator of relational database system 10. Adjusting the set time interval allows an administrator to define different amounts of time to fine tune the performance of the workload manager. The time interval may be set to any amount, but typically will be in the range of seconds or fractions of a second.

Once the set time interval has lapsed, the workload manager determines if any database queries are being executed by the RDBMS in step S302. According to one embodiment of the invention, this determination is made by monitoring the process threads being executed by the processor in relational database system 10. Each query being executed by the RDBMS is associated with a process thread executed by the processor. Using standard operating system commands or RDBMS commands, the workload manager identifies all process threads currently being executed by the processor. The workload manager determines which, if any, of the executing process threads are associated with executing queries in the RDBMS based on the identification information associated with each process thread. If no process threads are associated with an executing query, the operation of the workload manager returns to step S301 to wait for the time interval to lapse again. If one or more process threads are associated with an executing query, the operation of the workload manager continues on to step S303.

When each query is executed by the RDBMS, the associated process thread is assigned a processing priority value by the RDMBS and/or the operating system being executed on relational database system 10. As is understood by those skilled in the art, the assigned processing priority determines how much and/or how often processing resources will be allocated to executing the associated process thread. The assigned processing priority is a value selected from a range of values that vary depending on the operating system, processor, RDBMS, etc. of the relational database system. In addition, different types of processes are allocated different ranges of priority values. For example, real-time processes such as user I/O and critical system functions are assigned priority values from the top of a possible range of values. Less critical applications and processes are assigned priority values lower in the range. As the priority values decline, the associated process thread is moved more into the background and is deferred in favor of process threads having higher priority values.

In step S303, the workload manager reduces the processing priority value assigned to the process threads associated with executing queries. This results in executing queries being placed at a lower priority than new queries being executed by the RDBMS. According to one embodiment, the priority value is reduced by a single level in step S303. However, the amount of reduction in priority may be defined by an administrator of relational database system 10 to more than one level in alternative embodiments. Once the priority values of executing queries have been reduced, the process returns to the wait state represented by step S301. This cyclic process continues until either an administrator terminates the workload manager and/or the RDBMS being executed on relational database system 10.

The end result of the process represented in FIG. 3 is that all queries begin execution at a high priority and therefore initially are allocated a relatively high level of processing resources. Short executing queries that complete processing within the set time interval maintain their initial processing priority as if they were executing individually and alone on the system. Queries that require more time to complete will decrease in priority as they are executed so that they become background tasks and do not interfere with the short executing queries. Therefore, the queries that are naturally short executing will remain short executing regardless of level of concurrency. Since the user expects the long executing queries to take minutes to hours to complete, the slight additional time to completion within this system is mostly unnoticeable.

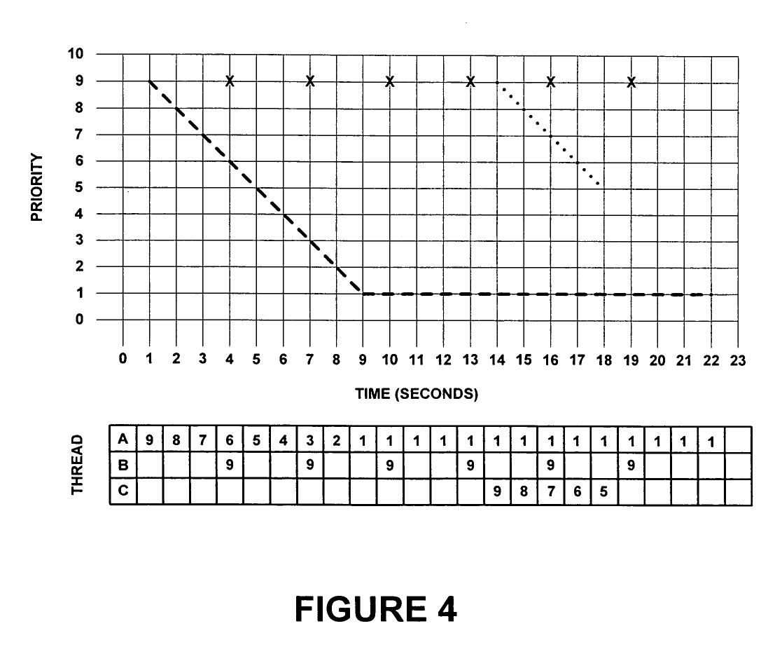

FIG. 4 is a graph depicting three process threads being managed by the workload manager at one-second time intervals, with a drop in priority of one value at each interval. Thread A, depicted with a dashed line, represents a long executing query. Thread B, depicted with an “X” represents multiple short executing queries. Thread C, depicted with a dotted line, represents a medium executing query. The table below the graph provides the processing priority assigned to each process thread at each time interval.

As shown in FIG. 4, each query is initially assigned a priority value of 9. As each one second time interval lapses, the priority values of each executing query are decreased by one. Accordingly, thread A is gradually reduced to a priority value of one so that more processor resources can be allocated to shorter executing queries. Thread B, on the other hand, includes six separate queries that are initiated and completed prior to the lapse of a single one time interval. Accordingly, the priority values of thread B are not reduced thereby allowing these short executing queries to be executed with high priority in a relatively short period of time. Thread C is gradually reduced to a priority value of 5 over several time interval lapses. As more time passes, the short executing queries are less and less affected by longer executing queries since the longer executing queries are slowly moved into the background. This demonstrates the ability of the workload manager to detect the type of query based on elapsed execution time, and adjust priority to allow short queries to have full or nearly full resources even within concurrent and mixed workloads.

The workload manager may be tuned to satisfy requirements for various implementations by determining how often priorities are changed, and by how much the priority changes at each interval. This provides a very easy to manage configuration that is not based on users or dedicated sessions and is invisible to the end user and the administrator of the system.

According to one embodiment of the invention, the workload manager is implemented as a process or application operating outside the RDBMS. Most RDBMS assign each individual query to a specific operating thread within the RDBMS or process within the operating system itself. The operating system then manages the assignment of resources to that thread or process in some standard manner, usually based on time slicing. Most operating systems allow some means for setting the priority of each thread or process in relation to other concurrently operating threads. A higher priority thread or process will receive more processing resources and therefore process more quickly than a lower priority thread or process. These concepts are well known to those skilled in the art of priority management.

In this embodiment, the outside workload manager monitors all the executing threads of the RDBMS and uses standard operating system controls to alter the priority of the executing threads based on the algorithm described above. In this embodiment, the RDBMS sets the priority to high (normal) at the start of each query and the workload manager adjusts it down as the set time intervals lapse. This embodiment implements the workload manager with minimal change to the RDBMS itself.

According to another embodiment of the invention, the workload manager is implemented within the RDMBS. In this alternative embodiment, the RDBMS contains a thread or process that monitors all of the threads associated with executing queries, and applies the algorithm for dynamically adjusting the priorities internally. This tracking thread adjusts the operating system priority of all query processing threads using operating system controls or calls.

Some RDBMS contain the ability to manage thread priority internally, without involving the operating system. In another alternative embodiment, the workload manager is implemented within the RDBMS to monitor the executing threads associated with executing queries and the priorities of the associated threads are dynamically adjusted in accordance with the algorithm described above using internal RDBMS controls.

According to another embodiment, the workload manager is implemented as an outside process or thread separate from the RDBMS to monitor query processing threads. The workload manager dynamically adjusts the priorities of the query processing threads using internal RDBMS controls by sending command instructions to the RDBMS using well known inter-process communication methods.

Manual control of the processing priority assigned to queries may be used by an administrator in combination with any of the embodiments described above. Specifically, manual controls for setting priorities may be used to override the automated assignment of priority to executing query processing threads. This override control may be used to manually set priorities for specific user accounts, for certain connections and/or for individual query executions, while all other queries are managed using one of the foregoing embodiments. For example, the workload management algorithm described above may be applied to only those queries originating from a group of users specified by an administrator. Similarly, queries from one or more users specified by an administrator may be excluded from application of the workload management algorithm and therefore be allowed to execute in a conventional manner.

The foregoing description is provided to enable one skilled in the art to practice the various embodiments of the invention described herein. Various modifications to these embodiments will be readily apparent to those skilled in the art, and generic principles defined herein may be applied to other embodiments. Thus, the following claims are not intended to be limited to the embodiments of the invention shown and described herein, but are to be accorded the full scope consistent with the language of the claims. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for managing a relational database workload, the method comprising the steps of:
monitoring executing queries in a relational database management system; and
reducing a priority assigned to each executing query at set time intervals.

2. The method for managing a relational database workload according to claim 1, wherein said monitoring step is executed at the set time intervals.

3. The method for managing a relational database workload according to claim 1, wherein said monitoring step comprises monitoring threads associated with respective executing queries.

4. The method for managing a relational database workload according to claim 1, wherein the set time intervals are administrator defined.

5. The method for managing a relational database workload according to claim 1, wherein said reducing step reduces the priority assigned to each executing query by an administrator-defined amount.

6. The method for managing a relational database workload according to claim 1, wherein said monitoring step comprises monitoring executing queries submitted by a specified group of users, and
wherein said reducing step comprises reducing the priority assigned to each executing query submitted by the specified group of users.

7. The method for managing a relational database workload according to claim 1, wherein administrator-specified queries are excluded from said reducing step.

8. A relational database workload manager, comprising:
a processing system configured to monitor executing queries in a relational database management system and to reduce a priority assigned to each executing query at set time intervals.

9. The relational database workload manager according to claim 8, wherein said processing system is configured to monitor the executing queries at the set time intervals.

10. The relational database workload manager according to claim 8, wherein said processing system is configured to monitor threads associated with respective executing queries.

11. The relational database workload manager according to claim 8, wherein the set time intervals are administrator defined.

12. The relational database workload manager according to claim 8, wherein said processing system is configured to reduce the priority assigned to each executing query by an administrator-defined amount.

13. The relational database workload manager according to claim 8, wherein said processing system is configured to monitor executing queries submitted by a specified group of users and to reduce the priority assigned to each executing query submitted by the specified group of users.

14. The relational database workload manager according to claim 8, wherein said processing system is configured to leave the priority assigned to administrator-specified queries unchanged.

15. A machine-readable medium comprising instructions executable by a processing system in a relational database workload manager, the instructions comprising the steps of:
monitoring executing queries in a relational database management system; and
reducing a priority assigned to each executing query at set time intervals.

16. The machine-readable medium according to claim 15, wherein said monitoring step is executed at the set time intervals.

17. The machine-readable medium according to claim 15, wherein said monitoring step comprises monitoring threads associated with respective executing queries.

18. The machine-readable medium according to claim 15, wherein the set time intervals are administrator defined.

19. The machine-readable medium according to claim 15, wherein said reducing step reduces the priority assigned to each executing query by an administrator-defined amount.

20. The machine-readable medium according to claim 15, wherein said monitoring step comprises monitoring executing queries submitted by a specified group of users, and wherein said reducing step comprises reducing the priority assigned to each executing query submitted by the specified group of users.

21. The machine-readable medium according to claim 15, wherein administrator-specified queries are excluded from said reducing step.
